(19) United States
(12) Patent Application Publication
(10) Pub. No.: US 2025/0386084 A1
(43) Pub. Date: Dec. 18, 2025

(54) IMAGING SYSTEM, MATRIX DATA, AND MATRIX DATA GENERATION METHOD

(71) Applicant: Panasonic Intellectual Property Management Co., Ltd., Osaka (JP)

(72) Inventor: CHIKAI HOSOKAWA, Osaka (JP)

(21) Appl. No.: 19/315,903

(22) Filed: Sep. 2, 2025

Related U.S. Application Data
(63) Continuation of application No. PCT/JP2024/008076, filed on Mar. 4, 2024.

(30) Foreign Application Priority Data
Mar. 20, 2023 (JP) 2023-044495

(51) Int. Cl. H04N 23/11; H04N 5/33; H04N 25/131

(52) U.S. Cl. CPC H04N 23/11; H04N 5/33; H04N 25/131

(57) ABSTRACT

An imaging system includes an imaging device that has an encoding element including regions whose transmission spectra differ from each other, a memory device that stores matrix data including N submatrices corresponding to N respective wavelength bands, and a processing circuit that generates N spectral images corresponding to the N respective wavelength bands, based on a compressed image generated by the imaging device and the matrix data, each submatrix includes numerical values corresponding to respective pixel values acquired through imaging based on light through the encoding element, in a case where a maximum value of each of the numerical values corresponding to a maximum value of a corresponding one of the pixel values determined by a number of bits is denoted by M and an average of the numerical values included in an i-th submatrix among the N submatrices is denoted by μi, i that satisfies μi≤0.8 M exists.

### BACKGROUND

### 1. Technical Field

The present disclosure relates to an imaging system, matrix data, and a matrix data generation method.

### 2. Description of the Related Art

Compressed sensing is a technique that reconstructs more data than observed data by assuming that the distribution of observation target data is sparse in a certain space, such as frequency space. Compressed sensing can be applied, for example, to an imaging device that reconstructs an image including more information from a small amount of observation data. An imaging device to which compressed sensing is applied generates spectral images corresponding to respective wavelength bands through operations from an image in which the spectral information of a target has been compressed. As a result, various effects on images can be obtained such as higher resolution, wavelength expansion, shorter imaging time, or higher sensitivity.

U.S. Pat. No. 9,599,511 discloses an example in which compressed sensing technology is applied to a hyperspectral camera that acquires spectral images. According to the technology disclosed in U.S. Pat. No. 9,599,511, it is possible to realize a hyperspectral camera that generates high-resolution and multi-wavelength images.

### SUMMARY

There is a need for imaging systems that can more accurately generate spectral images from images in which spectral information has been compressed.

In one general aspect, the techniques disclosed here feature an imaging system according to an aspect of the present disclosure, the imaging system including: an imaging device that has an encoding element including regions whose transmission spectra differ from each other, a memory device that stores matrix data including N submatrices corresponding to N respective wavelength bands, where N is an integer greater than or equal to 2, and a processing circuit that generates N spectral images corresponding to the N respective wavelength bands, based on a compressed image generated by the imaging device in which information regarding the N wavelength bands is compressed and the matrix data. Each of the N submatrices includes numerical values, the numerical values correspond to respective pixel values acquired through imaging based on light through the encoding element, a maximum value of each of the numerical values corresponds to a maximum value determined by a number of bits set for a corresponding one of the pixel values, and in a case where the maximum value of each of the numerical values is denoted by M and an average of the numerical values included in an i-th submatrix among the N submatrices is denoted by μi, where i is a natural number greater than or equal to 1 and less than or equal to N, i that satisfies μi≤0.8 M exists.

The comprehensive or specific aspects of the present disclosure may be realized by a system, apparatus, method, integrated circuit, computer program, or computer-readable recording medium, or in any combination of a system, apparatus, method, integrated circuit, computer program, and recording medium. Examples of the computer-readable recording medium include a nonvolatile recording medium such as a compact disc read-only memory (CD-ROM). The apparatus may be formed by one or more devices. In a case where the apparatus is formed by two or more devices, the two or more devices may be disposed in a single apparatus or may be disposed in two or more separate apparatuses in a divided manner. In this specification and the claims, an “apparatus” may refer not only to a single apparatus but also to a system formed by apparatuses.

According to the technology of the present disclosure, an imaging system can be realized that can more accurately generate spectral images from an image in which spectral information has been compressed.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram schematically illustrating an example of the configuration of an imaging system;

FIG. 1B is a diagram schematically illustrating another example of the configuration of the imaging system;

FIG. 1C is a diagram schematically illustrating yet another example of the configuration of the imaging system;

FIG. 1D is a diagram schematically illustrating yet another example of the configuration of the imaging system;

FIG. 2A is a diagram schematically illustrating an example of a filter array;

FIG. 2B includes diagrams illustrating an example of a spatial distribution of optical transmittance of each of wavelength bands included in a target wavelength range;

FIG. 2C is a diagram illustrating an example of the spectral transmittance of a region A1 included in the filter array illustrated in FIG. 2A;

FIG. 2D is a diagram illustrating an example of the spectral transmittance of a region A2 included in the filter array illustrated in FIG. 2A;

FIG. 3A is a diagram for describing an example of the relationship between the target wavelength range and the wavelength bands included in the target wavelength range;

FIG. 3B is a diagram for describing another example of the relationship between the target wavelength range and the wavelength bands included in the target wavelength range;

FIG. 4A is a diagram for describing characteristics of the spectral transmittance of a certain region of the filter array;

FIG. 4B is a diagram illustrating a result obtained by averaging, on a wavelength band basis, the spectral transmittance of each wavelength band illustrated in FIG. 4A;

FIG. 5 is a diagram schematically illustrating an example of the configuration of an imaging system for acquiring a reconstruction table from an encoding mask;

FIG. 6 is a flowchart schematically illustrating an example of a calibration operation performed by a processing circuit in the present embodiment;

FIG. 7A is a diagram schematically illustrating an example of the format of the reconstruction table;

FIG. 7B is a diagram schematically illustrating another example of the format of the reconstruction table;

FIG. 8 is a diagram schematically illustrating an example of the imaging system for generating a hyperspectral image from a compressed image;

FIG. 9 is a flowchart schematically illustrating an example of a hyperspectral image generation operation performed by the processing circuit in the present embodiment;

FIG. 10A is a diagram for describing a method for evaluating hyperspectral image reconstruction error;

FIG. 10B is a diagram for describing the method for evaluating hyperspectral image reconstruction error;

FIG. 10C is a diagram for describing the method for evaluating hyperspectral image reconstruction error;

FIG. 10D is a diagram for describing the method for evaluating hyperspectral image reconstruction error;

FIG. 11 is a graph representing the relationship between the average pixel value of each mask image included in the reconstruction table and the reconstruction error;

FIG. 12 is a schematic diagram illustrating the local spatial distributions of pixel values in a mask image corresponding to a certain wavelength band in an enlarged manner;

FIG. 13 is a diagram for describing an example of the filter array;

FIG. 14 is a diagram for describing an example of an image sensor; and

FIG. 15 is a diagram for describing an example of an image processing apparatus.

### DETAILED DESCRIPTIONS

In the present disclosure, all, one, or more of circuits, units, devices, members, or portions or all, one, or more of the functional blocks of a block diagram may be executed by, for example, one or more electronic circuits including a semiconductor device, a semiconductor integrated circuit (IC), or a large-scale integration circuit (LSI). The LSI or the IC may be integrated onto one chip or may be formed by combining chips. For example, functional blocks other than a storage device may be integrated onto one chip. In this case, the term LSI or IC is used; however, the term(s) to be used may change depending on the degree of integration, and the term such as system LSI, very large-scale integration circuit (VLSI), or ultra-large-scale integration circuit (ULSI) may be used. A field-programmable gate array (FPGA) or a reconfigurable logic device that allows reconfiguration of interconnection inside the LSI or setup of a circuit section inside the LSI can also be used for the same purpose, the FPGA and the reconfigurable logic device being programmed after the LSIs are manufactured.

Furthermore, functions or operations of all, one, or more of the circuits, the units, the devices, the members, or the portions can be executed through software processing. In this case, the software is recorded in one or more non-transitory recording media, such as a read-only memory (ROM), an optical disc, or a hard disk drive, and when the software is executed by a processing device (a processor), the function specified by the software is executed by the processing device and peripheral devices. The system or the apparatus may include the one or more non-transitory recording media in which the software is recorded, the processing device (the processor), and a hardware device to be needed, such as an interface.

In the present disclosure, “light” refers not only to visible light (wavelengths from about 400 nm to about 700 nm) but also to electromagnetic waves including ultraviolet rays (wavelengths from about 10 nm to about 400 nm) and infrared rays (wavelengths from about 700 nm to about 1 mm).

In the following, examples of embodiments of the present disclosure will be described. Note that any one of the embodiments to be described below is intended to represent a general or specific example. The numerical values, shapes, constituent elements, arrangement positions and connection forms of the constituent elements, steps, and the order of steps are examples and are not intended to limit the present disclosure. Among the constituent elements of the following embodiments, constituent elements that are not described in independent claims representing the most generic concept will be described as optional constituent elements. Each diagram is a schematic diagram and is not necessarily precisely illustrated. Furthermore, in each diagram, substantially the same or similar constituent elements are denoted by the same reference signs. Redundant description may be omitted or simplified.

Before describing the embodiments of the present disclosure, the possibility that images reconstructed on the basis of sparsity may have reconstruction errors will be described.

Sparsity is the property that the elements characterizing an observation target are present in a certain space, such as frequency space, in a sparse manner. Sparsity is widely observed in the natural world. The use of sparsity makes it possible to efficiently observe necessary information. Sparsity-based sensing technology is called compressed sensing. Compressed sensing technology can be used to construct highly efficient devices and systems.

As a specific application example of compressed sensing technology, a hyperspectral camera with improved wavelength resolution has been proposed, as disclosed in U.S. Pat. No. 9,599,511, for example. Such hyperspectral cameras are equipped, for example, with optical filters that have irregular optical transmission characteristics with respect to space, wavelength, or both. Such optical filters are also referred to as “encoding masks”. An encoding mask is disposed along an optical path of light incident on an image sensor and transmits the incident light from the target so as to have region-dependent optical transmission characteristics. This process performed by the encoding mask is referred to as “encoding”. The spectral information regarding the target is compressed in an image of the target acquired through the encoding mask. The image is referred to as a “compressed image”. Mask information indicating the optical transmittance characteristics of the encoding mask is stored in advance as a reconstruction table in the memory device.

The processing device of the imaging device performs a reconstruction process on the basis of the compressed image and the reconstruction table. Through the reconstruction process, reconstructed images are generated that have more information, such as higher resolution image information or image information covering more wavelengths, than the compressed image has. In this specification, the reconstructed images are also referred to as “spectral images”. The reconstruction table may be, for example, data reflecting the spatial distribution of the optical response characteristics of the encoding mask. The reconstruction process based on such a reconstruction table can generate reconstructed images, which correspond to the respective wavelength bands included in the target wavelength range, from a single compressed image.

The present inventor found that there is room for improving the reconstruction accuracy of the reconstructed images and arrived at an imaging system according to an embodiment of the present disclosure that solves this problem. With the imaging system according to the present embodiment, the use of a reconstruction table appropriately generated from an encoding mask makes it possible to more accurately generate reconstructed images from a compressed image. In the following, an imaging system according to an embodiment of the present disclosure is described.

### EMBODIMENT

In the following, first, an imaging system that generates reconstructed images from compressed images will be described. Next, reconstruction table generation and reconstruction error evaluation will be described.

### 1. Imaging System

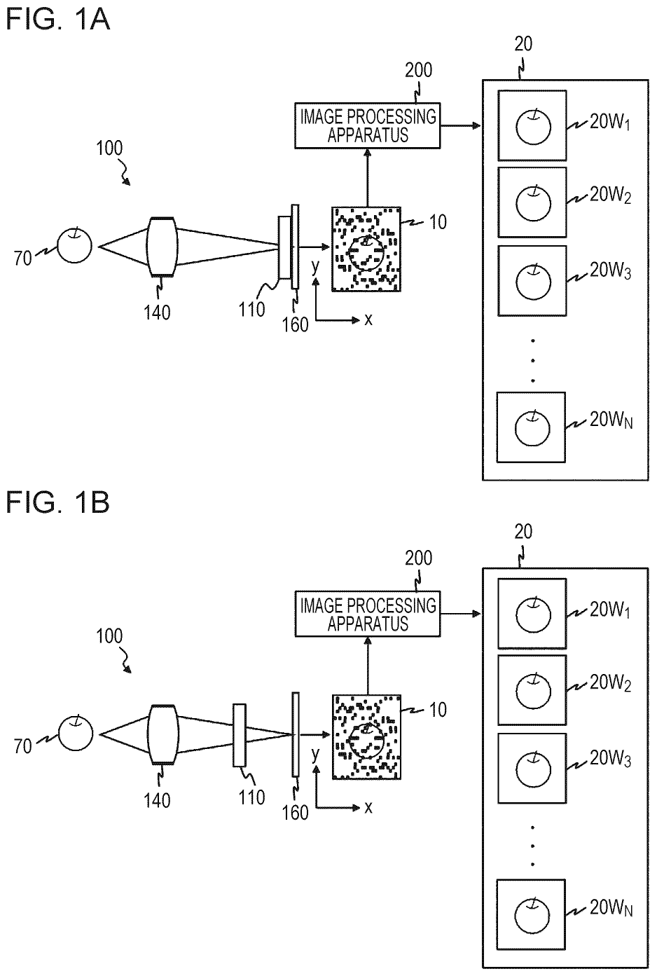

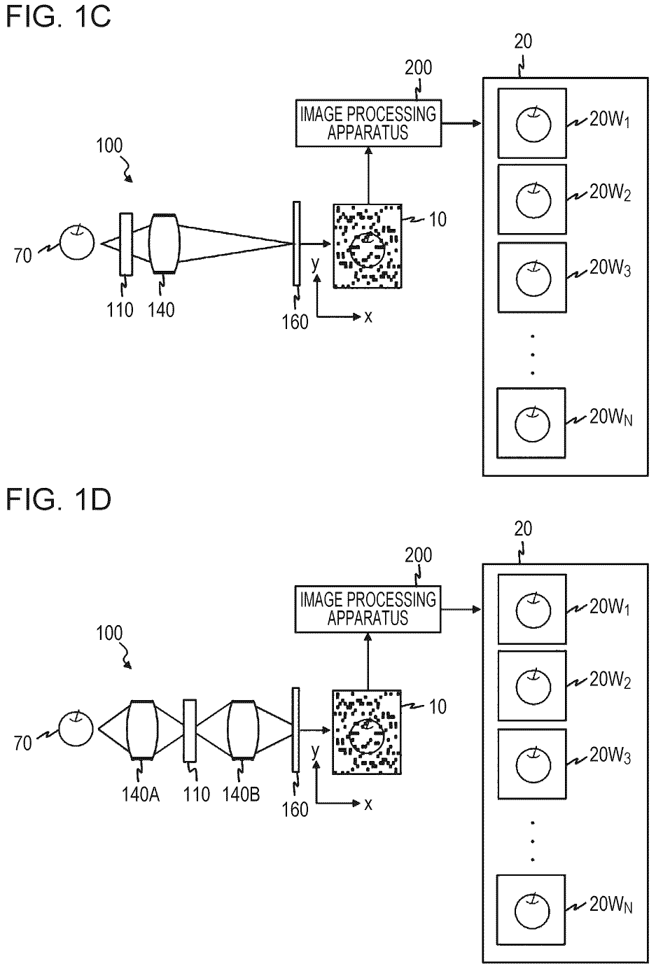

FIG. 1A is a diagram schematically illustrating an example of the configuration of an imaging system. The system illustrated in FIG. 1A includes an imaging device 100 and an image processing apparatus 200. The imaging device 100 has substantially the same configuration as the imaging device disclosed in U.S. Pat. No. 9,599,511. The imaging device 100 includes an optical system 140, a filter array 110, and an image sensor 160. The optical system 140 and the filter array 110 are disposed along an optical path of incident light from a target 70, which is a subject. The filter array 110 in the example illustrated in FIG. 1A is disposed between the optical system 140 and the image sensor 160.

FIG. 1A illustrates an apple as an example of the target 70. The target 70 is not limited to an apple, and may be any object. The image sensor 160 generates data of a compressed image 10, which is obtained by compressing information regarding wavelength bands into a two-dimensional monochrome image. The image processing apparatus 200 generates data representing images that correspond one-to-one to wavelength bands included in a predetermined target wavelength range, on the basis of the data of the compressed image 10 generated by the image sensor 160. In this case, suppose that the number of wavelength bands included in the target wavelength range is N (N is an integer greater than or equal to four). In the following description, N images generated on the basis of the compressed image 10 are referred to as reconstructed images 20W₁, 20W₂, . . . , 20W_{N}, and these images may also be referred to collectively as a “hyperspectral image 20”.

The filter array 110 in the present embodiment is an array of filters arranged in rows and columns and having translucency. The filters include different kinds of filters having different spectral transmittances from each other, that is, having different wavelength dependencies on optical transmittance from each other. The filter array 110 modulates the intensity of incident light for each wavelength and outputs the resulting light. This process performed by the filter array 110 will be referred to as “encoding”, and the filter array 110 will be also referred to as an “encoding mask”.

In the example illustrated in FIG. 1A, the filter array 110 is disposed near or directly on the image sensor 160. In this case, “near” refers to the filter array 110 being close enough to the image sensor 160 that an image of light from the optical system 140 is formed on the surface of the filter array 110 in a state where the image of light has a certain degree of clearness. “Directly on” refers to the filter array 110 and the image sensor 160 being close to each other to an extent that there is hardly any gap therebetween. The filter array 110 and the image sensor 160 may be formed as a single device.

The optical system 140 includes at least one lens. In FIG. 1A, the optical system 140 is illustrated as one lens; however, the optical system 140 may be a combination of lenses. The optical system 140 forms an image on an imaging surface of the image sensor 160 through the filter array 110.

The filter array 110 may be disposed so as to be spaced apart from the image sensor 160. FIGS. 1B to 1D are diagrams illustrating examples of the configuration of the imaging device 100, in which the filter array 110 is disposed so as to be spaced apart from the image sensor 160. In the example illustrated in FIG. 1B, the filter array 110 is disposed between the optical system 140 and the image sensor 160 and at a position spaced apart from the image sensor 160. In the example illustrated in FIG. 1C, the filter array 110 is disposed between the target 70 and the optical system 140. In the example illustrated in FIG. 1D, the imaging device 100 includes two optical systems 140A and 140B, and the filter array 110 is disposed between the optical systems 140A and 140B. As in these examples, an optical system including one or more lenses may be disposed between the filter array 110 and the image sensor 160.

The image sensor 160 is a monochrome light detector having light detection devices (also referred to as “pixels” in this specification) arranged two-dimensionally. The image sensor 160 may be, for example, a charge-coupled device (CCD), a complementary metal-oxide-semiconductor (CMOS) sensor, or an infrared array sensor. The light detection devices include, for example, a photodiode. The image sensor 160 is not necessarily a monochrome sensor. For example, color sensors may be used. A color sensor may include, for example, red (R) filters transmitting red light, green (G) filters transmitting green light, and blue (B) filters transmitting blue light. A color sensor may further include IR filters that transmit infrared light. Moreover, a color sensor may include transparent filters that transmit all red, green, and blue light. The use of a color sensor can increase the amount of information regarding wavelengths and improve the reconstruction accuracy of the hyperspectral image 20. A wavelength region as an acquisition target may be freely determined. The wavelength region is not limited to the visible wavelength region and may also be the ultraviolet wavelength region, the near infrared wavelength region, the mid-infrared wavelength region, or the far-infrared wavelength region.

The image processing apparatus 200 may be a computer including one or more processors and one or more storage media, such as a memory. The image processing apparatus 200 generates data of reconstructed images 20W₁, 20W₂, . . . , 20W_{N} on the basis of the compressed image 10 acquired by the image sensor 160.

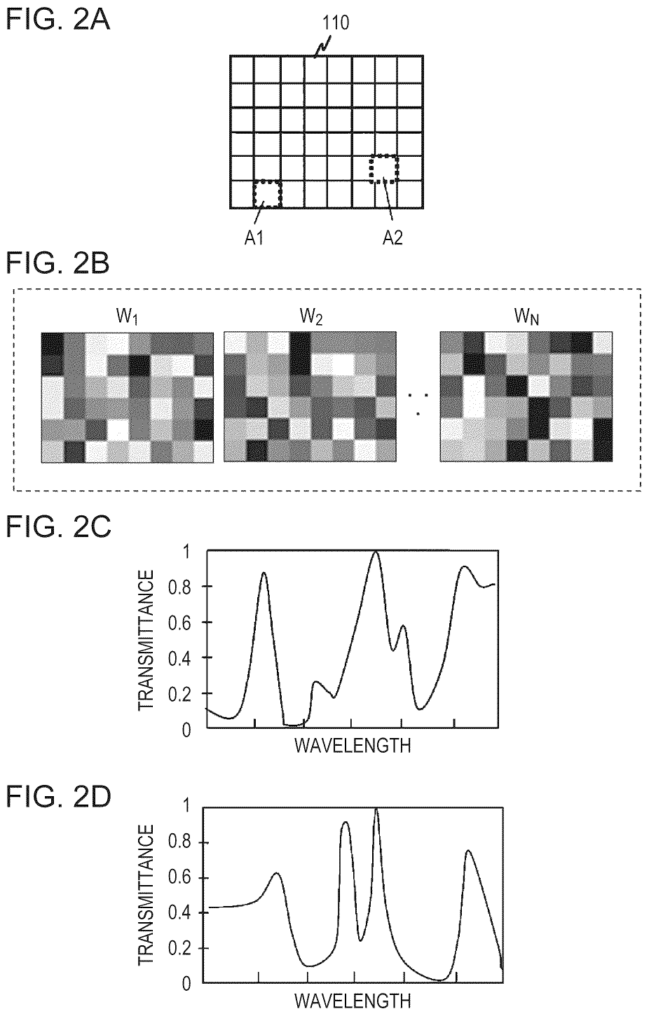

FIG. 2A is a diagram schematically illustrating an example of the filter array 110. The filter array 110 has regions arranged two-dimensionally. In this specification, these regions may be referred to as “cells”. In each region, an optical filter having a spectral transmittance set individually is disposed. Spectral transmittance is expressed by a function T(λ), where the wavelength of incident light is λ. The spectral transmittance T(λ) may have a value greater than or equal to 0 and less than or equal to 1.

In the example illustrated in FIG. 2A, the filter array 110 has 48 rectangular regions arranged in 6 rows and 8 columns. This is merely an example, and a larger number of regions than this may be provided in actual applications. The number of regions may be about the same as, for example, the number of pixels of the image sensor 160. The number of filters included in the filter array 110 is determined in accordance with applications, for example, within a range from several tens to several tens of millions.

FIG. 2B includes diagrams illustrating an example of a spatial distribution of optical transmittance of each of wavelength bands W₁, W₂, . . . , W_{N} included in the target wavelength range. In the example illustrated in FIG. 2B, differences in shading between the regions represent differences in transmittance. The lighter the shade of the region, the higher the transmittance. The darker the shade of the region, the lower the transmittance. As illustrated in FIG. 2B, the spatial distribution of optical transmittance differs depending on the wavelength band.

FIG. 2C is a diagram illustrating an example of the spectral transmittance of a region A1, and FIG. 2D is a diagram illustrating an example of the spectral transmittance of a region A2, the regions A1 and A2 being included in the filter array 110 illustrated in FIG. 2A. The spectral transmittance of the region A1 is different from that of the region A2. In this manner, the spectral transmittance of the filter array 110 varies depending on the region. Note that all the regions do not necessarily have different spectral transmittances from each other. At least some of the regions included in the filter array 110 have different spectral transmittances from each other. The filter array 110 includes two or more filters that have different spectral transmittances from each other. In one example, the number of patterns of spectral transmittances of the regions included in the filter array 110 may be the same as N, which is the number of wavelength bands included in the target wavelength range, or higher than N. The filter array 110 may be designed such that at least half of the regions have different spectral transmittances from each other.

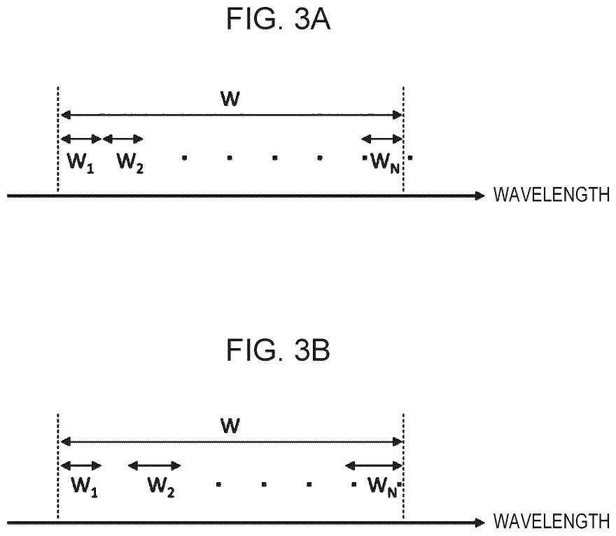

FIGS. 3A and 3B are diagrams for describing the relationships between a target wavelength range W and wavelength bands W₁, W₂, . . . , W_{N} included in the target wavelength range W. The target wavelength range W may be set to various ranges depending on the application. The target wavelength range W may have, for example, a wavelength range of visible light of about 400 nm to about 700 nm, a wavelength range of near infrared rays of about 700 nm to about 2500 nm, or a wavelength range of near ultraviolet rays of about 10 nm to about 400 nm. Alternatively, the target wavelength range W may be a wavelength range of mid-infrared rays or a wavelength range of far-infrared rays. In this manner, the wavelength range to be used is not limited to the visible light range. In this specification, not only visible light but also radiation in general including infrared rays and ultraviolet rays will be referred to as “light”.

In the example illustrated in FIG. 3A, N is set to any integer greater than or equal to 4, the target wavelength range W is equally divided into N sections, and the N wavelength ranges are referred to as the wavelength bands W₁, W₂, . . . , W_{N}. Note that the example is not limited to this one. The wavelength bands included in the target wavelength range W may be freely set. For example, the wavelength bands may have different bandwidths. There may be an overlap or a gap between adjacent wavelength bands among the wavelength bands. In the example illustrated in FIG. 3B, the wavelength bands have different bandwidths, and there is a gap between two adjacent wavelength bands among the wavelength bands. In this manner, the wavelength bands may be freely determined.

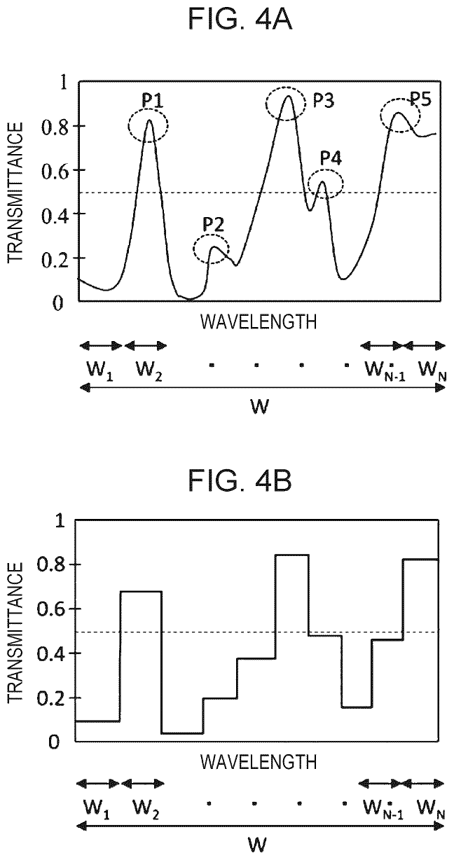

FIG. 4A is a diagram for describing characteristics of the spectral transmittance of a certain region of the filter array 110. In the example illustrated in FIG. 4A, regarding wavelengths within the target wavelength range W, the spectral transmittance has local maxima P1 to P5 and local minima. In the example illustrated in FIG. 4A, the optical transmittance within the target wavelength range W is normalized to have a maximum value of 1 and a minimum value of 0. In the example illustrated in FIG. 4A, the spectral transmittance has local maxima in wavelength ranges such as the wavelength band W₂ and the wavelength band W_{N-1}. In this manner, the spectral transmittance of each region may be designed to have local maxima in at least two wavelength ranges among the wavelength bands W₁, W₂, . . . , W_{N}. In the example illustrated in FIG. 4A, the local maxima P1, P3, P4, and P5 are greater than or equal to 0.5.

In this manner, the optical transmittance of each region varies with wavelength. Thus, the filter array 110 allows a large amount of a certain wavelength range component of incident light to pass therethrough but does not allow a large portion of another wavelength range component of incident light to pass therethrough. For example, the transmittance of light of k wavelength bands out of N wavelength bands may be greater than 0.5, and the transmittance of light of the other N−k wavelength ranges may be less than 0.5, where k is an integer that satisfies 2≤k<N. If incident light is white light, which includes all the visible light wavelength components equally, the filter array 110 modulates, on a region basis, the incident light into light having discrete peaks in intensity for wavelengths and superposes and outputs light of these multiple wavelengths.

FIG. 4B is a diagram illustrating, as one example, a result obtained by averaging, on a wavelength band basis, the spectral transmittance of each of the wavelength bands W₁, W₂, . . . , W_{N} illustrated in FIG. 4A. The average transmittance is obtained by integrating the spectral transmittance T(λ) for each wavelength band and performing division using the bandwidth of the wavelength band. In this specification, the value of average transmittance for each wavelength band obtained in this manner will be treated as the transmittance of the wavelength band. In this example, transmittance is prominently high in three wavelength ranges corresponding to the local maxima P1, P3, and P5. In particular, transmittance is higher than 0.8 in the two wavelength ranges corresponding to the local maxima P3 and P5.

In the example illustrated in FIGS. 2A to 2D, a gray scale transmittance distribution is assumed in which the transmittance of each region may have any value greater than or equal to 0 and less than or equal to 1. However, a gray scale transmittance distribution is not always needed. For example, a binary scale transmittance distribution may be used in which the transmittance of each region may have either a value of around 0 or a value of around 1. In a binary scale transmittance distribution, each region allows a large portion of light of at least two wavelength ranges among the wavelength ranges included in the target wavelength range to pass therethrough, and does not allow a large portion of light of the other wavelength ranges to pass therethrough. In this case, the “large portion” refers to about 80% or more.

Some of all the cells, for example, half the cells may be replaced with transparent regions. Such transparent regions allow light of each of the wavelength bands W₁, W₂, . . . , W_{N} included in the target wavelength range W to pass therethrough at a similarly high transmittance, for example, 80% or higher. With such a configuration, the transparent regions are disposed, for example, in a checkerboard manner. That is, the regions having optical transmittance that varies with wavelength and the transparent regions may be arranged in an alternating manner in two directions of the arrayed regions in the filter array 110.

Data representing such a spatial distribution of the spectral transmittance of the filter array 110 is acquired beforehand on the basis of design data or by performing actual measurement calibration, and is stored in a storage medium of the image processing apparatus 200. This data is used in arithmetic processing to be described later.

The filter array 110 may be formed using, for example, multi-layer films, organic materials, diffraction grating structures, or metal-containing microstructures. In a case where a multi-layer film is used, for example, a dielectric multilayer film or a multi-layer film including a metal layer may be used. In this case, the cells are formed such that at least the thicknesses, materials, or stacking orders of the layers of the multi-layer film are made different from cell to cell. As a result, spectral characteristics that are different from cell to cell can be realized. By using a multi-layer film, a sharp rising edge and a sharp falling edge can be realized for spectral transmittance. A configuration using organic material can be realized by causing different cells to contain different pigments or dyes or by causing different cells to have different stacks of layers of materials. A configuration using a diffraction grating structure can be realized by causing different cells to have structures with different diffraction pitches or different depths. In a case where a metal-containing microstructure is used, a configuration can be fabricated using plasmon effect spectroscopy.

Next, an example of signal processing performed by the image processing apparatus 200 will be described. The image processing apparatus 200 reconstructs a hyperspectral image 20, which is a multi-wavelength image, on the basis of the compressed image 10 output from the image sensor 160 and characteristics of a transmittance spatial distribution for each wavelength of the filter array 110. In this case, “multi-wavelength” refers to, for example, more wavelength ranges than 3-color wavelength ranges, which are RGB wavelength ranges, acquired by normal color cameras. The number of such wavelength ranges may be, for example, any number between 4 and about 100. The number of such wavelength ranges will be referred to as the “number of bands”. Depending on applications, the number of bands may exceed 100.

Data to be obtained is data of the hyperspectral image 20, and the data will be denoted by f. If the number of bands is N, f is data obtained by integrating data f₁, f₂, . . . , f_{N} of N bands. In this case, suppose that the horizontal direction of the image is the x-direction, and the vertical direction of the image is the y-direction. When the number of pixels in the x-direction for the image data to be obtained is m, and the number of pixels in the y-direction for the image data to be obtained is n, each of the image data f₁, f₂, . . . , f_{N} has n×m pixel values. Thus, the data f is data having n×m×N elements. In contrast, data g of the compressed image 10 acquired by the filter array 110 through encoding and multiplexing has n×m elements. The data g can be expressed by the following Eq. (1).

$$g = H f = H [ \begin{matrix}{f}_{1} \\ {f}_{2} \\ ⋮ \\ {f}_{N}\end{matrix} ] \qquad ( 1 )$$

In Eq. (1), f represents the data of the hyperspectral image expressed as a one-dimensional vector. Each of f₁, f₂, . . . , and f_{N} has n×m elements. Thus, the vector on the right side is a one-dimensional vector having n×m×N rows and one column. The data g of the compressed image is calculated as a one-dimensional vector having n×m rows and one column. A matrix H represents a conversion in which individual components f₁, f₂, . . . , f_{N} of the vector f are encoded and intensity-modulated using encoding information that varies depending on the wavelength band, and are then added to one another. Thus, H denotes a matrix having n×m rows and n×m×N columns. Eq. (1) can also be expressed as follows.

$$g = {( p {g}_{11} … {pg}_{1 m} … {pg}_{n 1} … {pg}_{n m} )}^{T} = {H ( {f}_{1} … {f}_{N} )}^{T} ,$$

where pgᵢⱼ denotes the pixel value in the i-th row and j-th column of the compressed image 10.

When the vector g and the matrix H are given, it seems that the data f can be calculated by solving an inverse problem of Eq. (1). However, the number of elements (n×m×N) of the data f to be obtained is greater than the number of elements (n×m) of the acquired data g, and thus this problem is an ill-posed problem, and the problem cannot be solved as is. Thus, the image processing apparatus 200 uses the redundancy of the images included in the data f and uses a compressed sensing method to obtain a solution. Specifically, the data f to be obtained is estimated by solving the following Eq. (2).

$${f}^{′} = {arg min}_{f} \{ {‖ g - Hf ‖}_{{l}_{2}} + τ Φ ( f ) \} \qquad ( 2 )$$

In this case, f denotes the data of the estimated f. The first term in the braces of the equation above represents a shift between an estimation result Hf and the acquired data g, which is a so-called residual term. In this case, the sum of squares is treated as the residual term; however, an absolute value, a root-sum-square value, or the like may be treated as the residual term. The second term in the braces is a regularization term or a stabilization term. Eq. (2) means to obtain f that minimizes the sum of the first term and the second term. The function in the braces in Eq. (2) is called an evaluation function. The image processing apparatus 200 can cause the solution to converge through a recursive iterative operation and can calculate f that minimizes the evaluation function as a final solution f.

The first term in the braces of Eq. (2) refers to a calculation for obtaining the sum of squares of the differences between the acquired data g and Hf, which is obtained by converting f in the estimation process using the matrix H. The second term Φ(f) is a constraint for regularization of f and is a function that reflects sparse information regarding estimated data. This function has the effect of making the estimated data smooth and stable. The regularization term can be expressed using, for example, discrete cosine transformation (DCT), wavelet transform, Fourier transform, or total variation (TV) of f. For example, in a case where total variation is used, stabilized estimated data can be acquired in which the effect of noise of the data g, observation data, is suppressed. The sparsity of the target 70 in the space of each regularization term differs with the texture of the target 70. A regularization term for which the texture of the target 70 becomes sparser in the space of the regularization term may be selected. Alternatively, regularization terms may be included in calculation. τ is a weighting factor. The greater the weighting factor τ, the greater the amount of reduction of redundant data, thereby increasing a compression rate. The smaller the weighting factor τ, the lower the convergence to the solution. The weighting factor τ is set to an appropriate value with which f is converged to a certain degree and is not compressed too much.

Note that, in the configurations illustrated in FIGS. 1B and 1C, images encoded by the filter array 110 are acquired in bokeh states on the imaging surface of the image sensor 160. Thus, the hyperspectral image 20 can be reconstructed by reflecting the bokeh information in the above-described matrix H, the bokeh information being stored in advance. In this case, the bokeh information is expressed by a point spread function (PSF). The PSF is a function that defines the degree of spread of a point image to its surrounding pixels. For example, in a case where a point image corresponding to one pixel on an image is spread to a region of k×k pixels around the pixel due to bokeh, the PSF can be defined as a group of factors, that is, a matrix indicating the effect on the pixel value of each pixel in the region. The effect of bokeh on an encoding pattern expressed by the PSF is reflected in the matrix H, so that the hyperspectral image 20 can be reconstructed. The filter array 110 may be disposed at any position; however, a position may be selected where the encoding pattern of the filter array 110 does not spread so much as to disappear.

Through the above-described process, the hyperspectral image 20 can be reconstructed from the compressed image 10 acquired by the image sensor 160. Details of the method for reconstructing the hyperspectral image 20 are disclosed in U.S. Pat. No. 9,599,511.

Next, another example of the configuration of the imaging device 100 will be described. The compressed image and the hyperspectral image may be generated through imaging using a different method from the above-mentioned imaging using the filter array 110 including the optical filters, namely an encoding mask.

For example, as the configuration of the imaging device 100, the light receiving characteristics of the image sensor 160 may be changed for each pixel by applying processing to the image sensor 160. Similarly to the above-mentioned example, compressed images can be generated through imaging using the image sensor 160 to which the processing has been applied. That is, a compressed image may be generated by an imaging device configured with the filter array 110 built into the image sensor 160. In this case, the encoding information corresponds to the light receiving characteristics of the image sensor 160.

A configuration may be employed in which the optical properties of the optical system 140 are changed spatially and spectrally by introducing an optical element, such as a metalens, into at least part of the optical system 140, thereby compressing the spectral information. An imaging device including that configuration can also generate compressed images. In this case, the encoding information is information corresponding to the optical properties of the optical element, such as a metalens. In this manner, the imaging device 100, which has a different configuration from that using the filter array 110, may be used to modulate the intensity of the incident light on a wavelength basis to generate the compressed image 10 and the hyperspectral image 20.

In other words, the present disclosure may also include a configuration for generating a reconstructed image including the number of signals exceeding the number of signals (for example, the number of pixels) included in the compressed image 10 on the basis of encoding information corresponding to the optical response characteristics of the imaging device 100, which includes light reception regions having different optical response characteristics from each other, and the compressed image 10 generated by the imaging device 100. As mentioned above, the optical response characteristics may correspond to the light receiving characteristics of the image sensor and also correspond to the optical properties of the optical element.

Thus, it can be said that the imaging device 100 according to the present embodiment includes an encoding element that includes light reception regions having different optical response characteristics from each other. In this case, “encoding element” refers not only to an encoding mask but also to the optical system 140 with optical properties that are changed spatially and spectrally.

### 2. Generation of Reconstruction Table

Next, an example of an imaging system for generating a reconstruction table from an encoding mask and an example of its operation will be described. The encoding mask includes regions having different transmission spectra from each other. By appropriately generating a reconstruction table from such an encoding mask, the reconstruction error of a hyperspectral image can be effectively reduced.

2.1. Imaging System for Generating Reconstruction Table from Encoding Mask

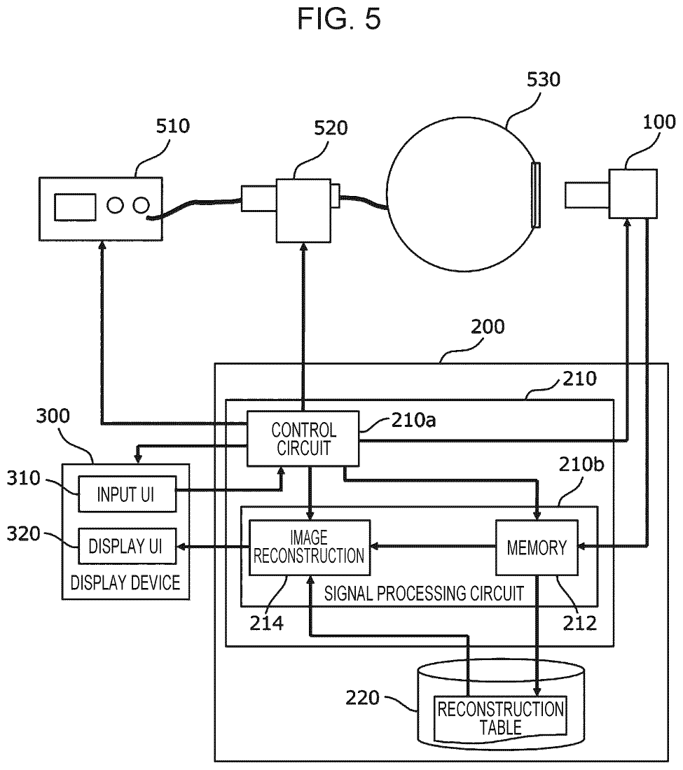

FIG. 5 is a diagram schematically including an example of the configuration of an imaging system for generating a reconstruction table from an encoding mask. The imaging system illustrated in FIG. 5 includes a light source 510, a monochromator 520, an integrating sphere 530, the imaging device 100, the image processing apparatus 200, and a display device 300. Lines with arrows represent signal transmission and reception.

In the following, each structural element of the imaging system illustrated in FIG. 5 will be described. Note that some of the following structural elements are not always necessary for generating a reconstruction table and are used to generate, output, and display hyperspectral images.

The light source 510 emits light that includes all components of wavelength bands within the target wavelength range. If the target wavelength range is at least part of the visible light range, the light can be white light, for example. Light emitted from the light source 510 can be but is not limited to laser light, for example. Light emitted from the light source 510 may be light from a light-emitting diode (LED) or from a light bulb, for example. The monochromator 520 extracts light of a certain wavelength band from laser light emitted from the light source 510. Instead of the monochromator 520, a bandpass filter may be used to extract light of the certain wavelength band. The integrating sphere 530 has an aperture and emits the extracted monochromatic light spatially uniformly through the aperture. The imaging device 100 acquires an image of the light emitted from the integrating sphere 530.

Thick curved lines illustrated in FIG. 5 represent an optical fiber connecting the light source 510 and the monochromator 520 to each other and an optical fiber connecting the monochromator 520 and the integrating sphere 530 to each other. The optical fiber connecting the light source 510 and the monochromator 520 to each other guides the laser light emitted from the light source 510 to the monochromator 520. The optical fiber connecting the monochromator 520 and the integrating sphere 530 to each other guides the light emitted from the monochromator 520 to the integrating sphere 530. Mirrors may be used instead of the optical fibers.

The image processing apparatus 200 includes a processing circuit 210, which includes a control circuit 210a and a signal processing circuit 210b, and a storage device 220. The control circuit 210a controls the operations of the light source 510, the monochromator 520, the imaging device 100, the signal processing circuit 210b, and the display device 300. The signal processing circuit 210b includes a memory 212 and an image reconstruction module 214. The memory 212 stores images acquired through calibration described below. The image reconstruction module 214 generates, from a compressed image generated by the imaging device 100, a hyperspectral image through a reconstruction operation and outputs information regarding the hyperspectral image. The information is sent to the display device 300.

The signal processing circuit 210b includes the memory 212 and a processor that functions as the image reconstruction module 214. In the example illustrated in FIG. 5, the control circuit 210a and the signal processing circuit 210b are illustrated as separate circuits but may be a single circuit.

The storage device 220 includes one or more storage media. Each storage medium may be any storage medium, such as a semiconductor memory, a magnetic storage medium, or an optical storage medium, for example. The storage device 220 stores a reconstruction table generated through the calibration described below. The reconstruction table is an example of encoding information indicating the optical transmission characteristics of the filter array 110, which functions as an encoding mask.

The display device 300 displays an input user interface (UI) 310 and a display UI 320. The input UI 310 is used by the user to input information. The information input by the user through the input UI 310 is received by the control circuit 210a. The display UI 320 is used to display information regarding hyperspectral images.

The input UI 310 and the display UI 320 are displayed as a graphical user interface (GUI). The information presented through the input UI 310 and the display UI 320 can also be said to be displayed by the display device 300. The input UI 310 and the display UI 320 may be realized by a device that allows both input and output, such as a touch screen. In such cases, the touch screen may function as the display device 300. In a case where a keyboard, a mouse, or both are used as the input UI 310, the input UI 310 is a device independent of the display device 300.

The imaging system illustrated in FIG. 5 does not always need to have the image reconstruction module 214 and the display device 300 among the above-mentioned structural elements. This is because these structural elements are used to generate hyperspectral images and to output and display information regarding hyperspectral images, as described below.

### 2.2. Calibration Operation for Generating Reconstruction Table

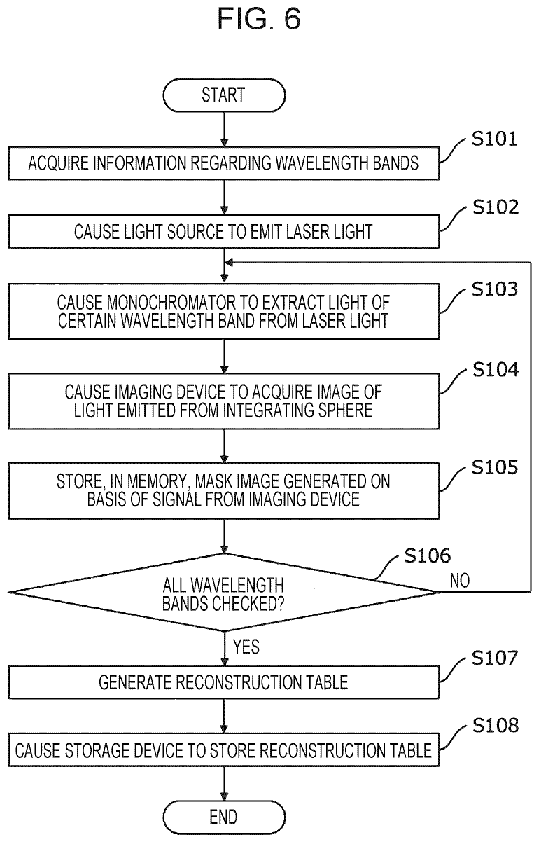

Next, with reference to FIG. 6, an example of a calibration operation performed by the processing circuit 210 in the present embodiment will be described. Such calibration makes it possible to generate a reconstruction table that can effectively reduce reconstruction errors.

FIG. 6 is a flowchart schematically illustrating an example of the calibration operation performed by the processing circuit 210 in the present embodiment. The control circuit 210a or signal processing circuit 210b included in the processing circuit 210 performs the operations in Steps S101 to S108 illustrated in FIG. 6. The signal processing circuit 210b performs operations in response to control signals from the control circuit 210a. In this specification, the operation performed by the control circuit 210a or signal processing circuit 210b is treated as an operation performed by the processing circuit 210.

### Step S101

The user sets, through the input UI 310 illustrated in FIG. 5, N wavelength bands (N is an integer greater than or equal to 2) included in the target wavelength range. The control circuit 210a acquires information regarding the N wavelength bands from the input UI 310.

### Step S102

The control circuit 210a causes the light source 510 to emit laser light including components of the N wavelength bands. The laser light is, for example, white laser light.

### Step S103

The control circuit 210a causes the monochromator 520 to extract light of a certain wavelength band from the laser light. This wavelength band is one of the N input wavelength bands.

### Step S104

The control circuit 210a causes the imaging device 100 to acquire, under adjusted imaging conditions, an image of light emitted from the integrating sphere 530 as follows. The control circuit 210a causes the light source 510 to adjust the intensity of laser light to be emitted from the light source 510 or adjust the exposure time of the imaging device 100 so that the average pixel value of pixels included in the acquired image falls within a predetermined range. The predetermined range, which enables effective reduction of the reconstruction error, will be described below.

In a case where the number of bits for pixel values is, for example, 10, the pixel values are represented using 1024 gradations. In this case, the pixel values are integers greater than or equal to 0 and less than or equal to 1023. Alternatively, in a case where the number of bits for pixel values is, for example, 8, the pixel values are represented using 256 gradations. In this case, the pixel values are integers greater than or equal to 0 and less than or equal to 255.

### Step S105

The signal processing circuit 210b stores, in the memory 212, a mask image generated on the basis of a signal from the imaging device 100 and corresponding to the above-mentioned certain wavelength band.

### Step S106

The control circuit 210a determines whether or not all the wavelength bands have been checked. In a case where a determination of Yes is obtained, the signal processing circuit 210b performs the operation in Step S107. In a case where a determination of No is obtained, the control circuit 210a performs the operation in Step S103 again. In Step S103, the control circuit 210a causes the monochromator 520 to extract light of a wavelength band that has not yet been checked from the laser light. This extraction may be performed in order from the shortest to the longest wavelength. In this manner, the control circuit 210a performs the operations in Steps S103 to S105 repeatedly for the N input wavelength bands to generate mask images.

### Step S107

The signal processing circuit 210b generates a reconstruction table on the basis of the N mask images corresponding to the N respective wavelength bands.

### Step S108

The signal processing circuit 210b causes the storage device 220 to store the reconstruction table.

The above-mentioned calibration operation makes it possible to generate, from the encoding mask included in the imaging device 100, the reconstruction table including the N mask images whose average pixel values fall within a predetermined range. All the N mask images may have the same average pixel value. Alternatively, the mask images may have different average pixel values from each other. Some of the mask images may have different average pixel values from that of the rest of the mask images.

### 2.2. Reconstruction Table Format

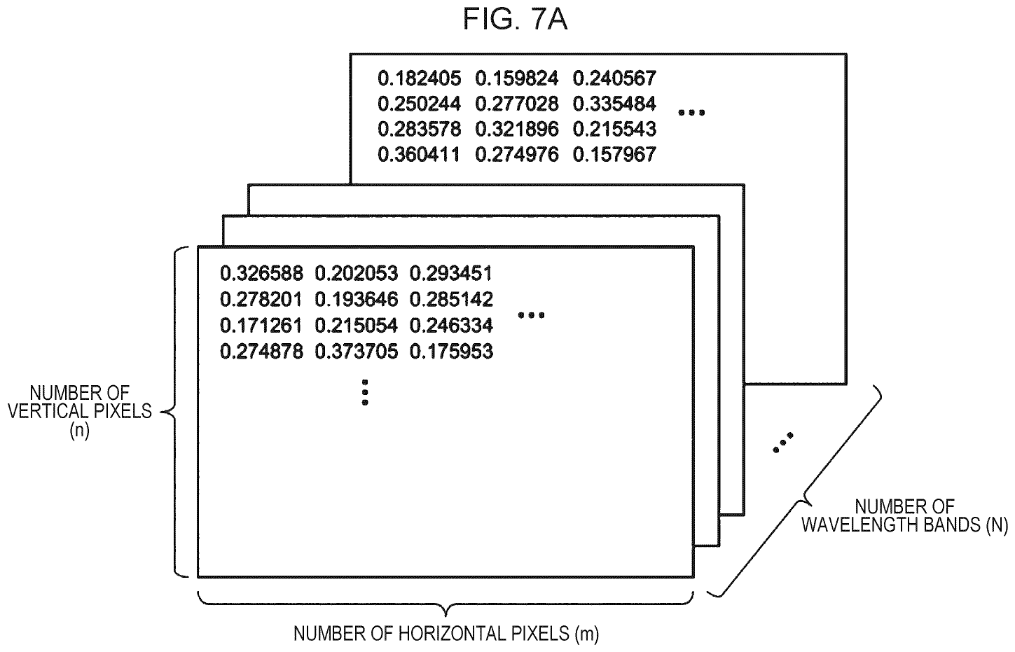

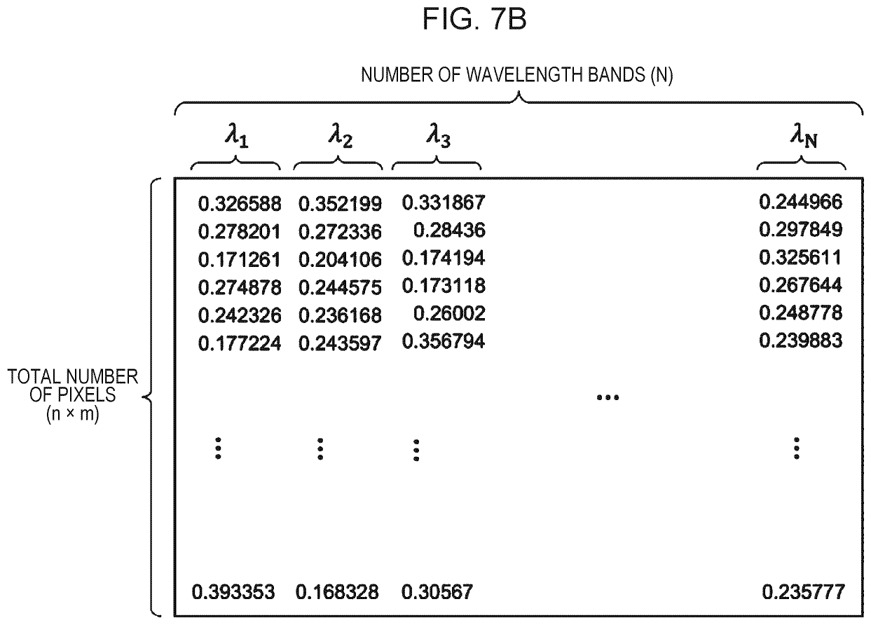

Next, an example of the format of the reconstruction table will be described with reference to FIGS. 7A and 7B. FIGS. 7A and 7B are diagrams schematically illustrating examples of the format of the reconstruction table. The reconstruction table illustrated in FIG. 7A is represented as a three-dimensional matrix whose depth represents the wavelength bands and whose height and width represent the pixel values of the pixels included in each mask image. The reconstruction table illustrated in FIG. 7B is represented as a two-dimensional matrix whose width represents the wavelength bands and whose height represents the pixel values of the pixels included in each mask image.

As illustrated in FIGS. 7A and 7B, the reconstruction table is matrix data including N submatrices corresponding to the N respective wavelength bands. Each of the N submatrices includes numerical values. Each of the numerical values corresponds to a corresponding one of pixel values acquired through imaging based on light through the encoding mask. The maximum value of each of the numerical values corresponds to the maximum value determined by the number of bits set for a corresponding one of the pixel values. In the examples illustrated in FIGS. 7A and 7B, each of the numerical values included in each submatrix is normalized by the maximum value represented by the number of bits to be greater than or equal to 0 and less than or equal to 1. However, such normalization is not always necessary. Each of the numerical values included in each submatrix may be, for example, greater than or equal to 0 and less than or equal to 50.

In the example illustrated in FIG. 7A, each submatrix is a two-dimensional matrix having n rows and m columns and representing the two-dimensional distribution of numerical values. Such a two-dimensional matrix makes it easier to understand the way in which pixel values are distributed two-dimensionally for a certain wavelength band.

In the example illustrated in FIG. 7B, each submatrix is a one-dimensional matrix that has n×m rows and one column and in which numerical values are arranged one-dimensionally, namely a vector. Such a one-dimensional matrix makes it possible to represent the N mask images corresponding to the N respective wavelength bands as a two-dimensional matrix.

The format of the reconstruction table is not limited to the examples illustrated in FIGS. 7A and 7B. For example, the reconstruction table illustrated in FIG. 7A may also be represented as a two-dimensional matrix having n×N rows and m columns or a two-dimensional matrix having n rows and m×N columns obtained by arranging the N two-dimensional matrices vertically or horizontally. Alternatively, the reconstruction table illustrated in FIG. 7B may also be represented as a one-dimensional matrix having n×m×N rows and 1 column by arranging the N one-dimensional matrices vertically.

### 3. Reconstruction Error Evaluation

Next, an example of an imaging system for generating a hyperspectral image from a compressed image, an example of the operation of the imaging system, and reconstruction error evaluation will be described.

3.1. Imaging System for Generating Hyperspectral Image from Compressed Image

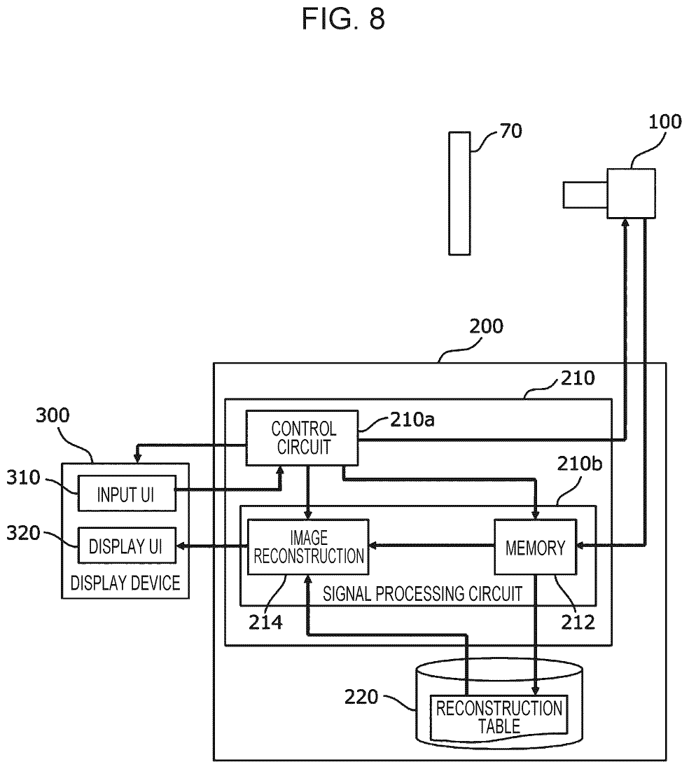

Next, with reference to FIG. 8, an example of an imaging system for generating a hyperspectral image from a compressed image will be described. FIG. 8 is a diagram schematically illustrating an example of the imaging system for generating a hyperspectral image from a compressed image. The imaging system illustrated in FIG. 8 captures an image of the target 70 to generate its hyperspectral image.

The imaging system illustrated in FIG. 8 is similar to the imaging system illustrated in FIG. 5 and includes the imaging device 100, the image processing apparatus 200, and the display device 300. The storage device 220 included in the image processing apparatus 200 stores the reconstruction table generated through the above-mentioned calibration operation. The imaging system illustrated in FIG. 8 is different from the imaging system illustrated in FIG. 5 and does not include the light source 510, the monochromator 520, or the integrating sphere 530.

### 3.2. Operation for Generating Hyperspectral Image

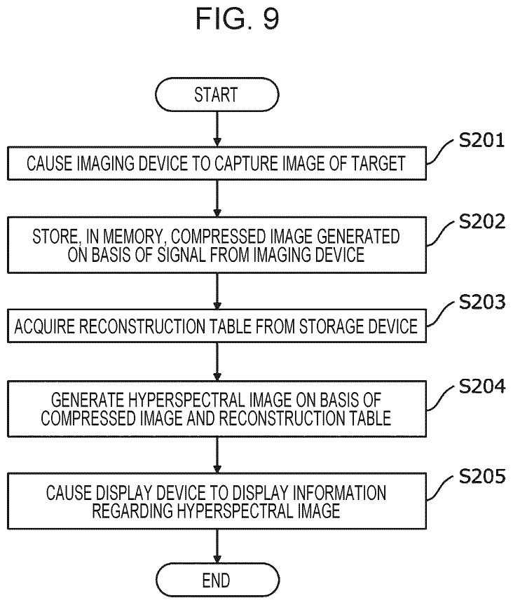

Next, an example of a hyperspectral image generation operation performed by the processing circuit 210 in the present embodiment will be described with reference to FIG. 9.

FIG. 9 is a flowchart schematically illustrating an example of an operation performed by the processing circuit 210 in the present embodiment to generate reconstructed images. The control circuit 210a or signal processing circuit 210b included in the processing circuit 210 performs the operations in Steps S201 to S205 illustrated in FIG. 9.

### Step S201

The control circuit 210a causes the imaging device 100 to capture an image of the target 70.

### Step S202

The signal processing circuit 210b stores, in the memory 212, a compressed image of the target 70 generated on the basis of a signal from the imaging device 100. In the compressed image, information regarding the N wavelength bands about the target 70 is compressed.

### Step S203

The signal processing circuit 210b acquires the reconstruction table from the storage device 220.

### Step S204

In the image reconstruction module 214, the signal processing circuit 210b generates a hyperspectral image on the basis of the compressed image stored in the memory 212 and the reconstruction table and outputs information regarding the hyperspectral image. The hyperspectral image includes N reconstructed images corresponding to the N respective wavelength bands, namely N spectral images.

### Step S205

The signal processing circuit 210b causes the display device 300 to display information regarding the hyperspectral image. In a case where the user specifies a certain portion of the target 70 via the display UI 320, the display UI 320 may display spectral information regarding that portion.

Through the above-mentioned operation, the hyperspectral image of the target 70 can be generated. In the above-mentioned example, the signal processing circuit 210b acquires the reconstruction table from the storage device 220 but is not limited to this example. In a case where the reconstruction table is stored in an external server, such as the cloud, the signal processing circuit 210b may acquire the reconstruction table from the external server. In that case, the imaging system illustrated in FIG. 8 does not need to have the storage device 220.

### 3.3. Method for Evaluating Hyperspectral Image Reconstruction Error

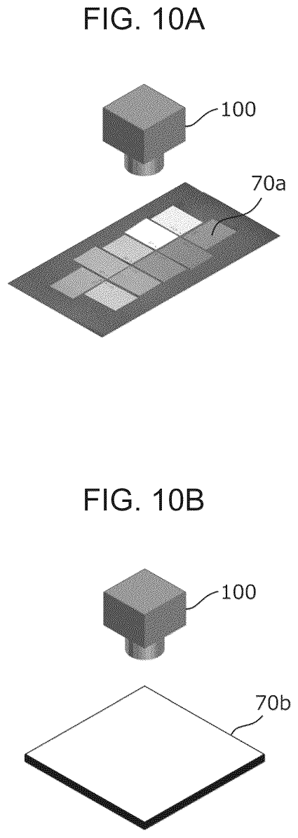

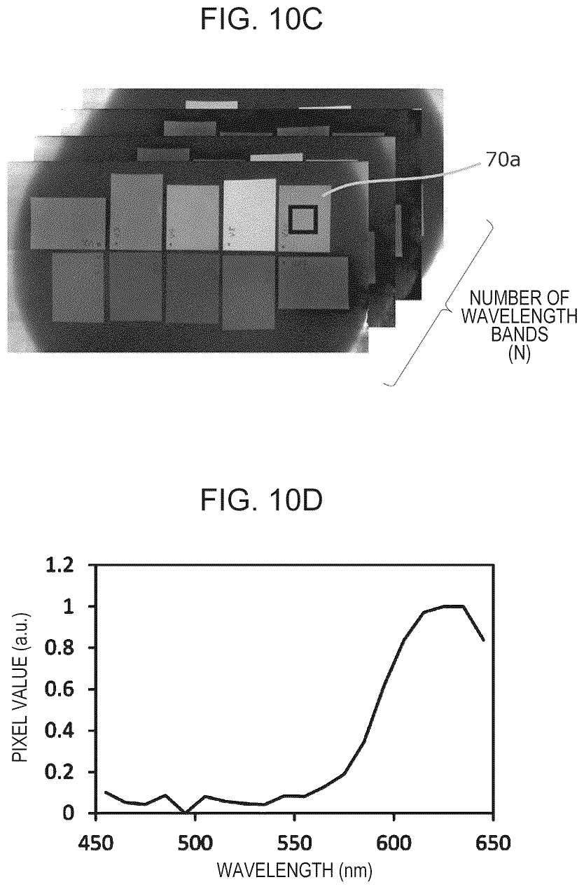

Next, with reference to FIGS. 10A to 10D, a method for evaluating hyperspectral image reconstruction error will be described. FIGS. 10A to 10D are diagrams for describing a method for evaluating hyperspectral image reconstruction error. As illustrated in FIG. 10A, the imaging device 100 captures an image of color samples 70a, which are arranged two-dimensionally, as the target 70 illustrated in FIG. 8. Next, as illustrated in FIG. 10B, the imaging device 100 captures an image of a white plate 70b as the target 70 illustrated in FIG. 8. A first hyperspectral image, which is obtained from the captured image of the color samples 70a, is normalized by a second hyperspectral image, which is obtained from the captured image of the white plate 70b.

Normalization will be as follows. For the first hyperspectral image, the pixel value of the pixel at the i-th row and the j-th column among the pixels included in a reconstructed image corresponding to a certain wavelength band is treated as a first pixel value. For the second hyperspectral image, the pixel value of the pixel at the i-th row and the j-th column among the pixels included in a reconstructed image corresponding to that certain wavelength band is treated as a second pixel value. In normalization, the operation of dividing the first pixel value by the second pixel value is performed for all pixels. In this manner, the normalized hyperspectral image for the color samples 70a is obtained as illustrated in FIG. 10C. Furthermore, as illustrated in FIG. 10D, the spectrum of a certain color sample 70a among the color samples 70a is obtained from the portion of the normalized hyperspectral image illustrated in FIG. 10C that is encircled by the bold rectangle.

When the color samples 70a are numbered, the spectrum of the i-th color sample 70a obtained from the normalized hyperspectral image is denoted by αᵢ(λ), and the ground-truth spectrum of the i-th color sample 70a is denoted by βᵢ(λ). When the N wavelength bands are numbered, the center wavelength of the n-th wavelength band is denoted by λₙ. In this case, the error rate of the i-th color sample 70a is expressed by the following Eq. (3).

$${ε}_{i} = \frac{1}{N} {\sum }_{n = 1}^{N} \vert {α}_{i} ( {λ}_{n} ) - {β}_{i} ( {λ}_{n} ) \vert \qquad ( 3 )$$

A reconstruction error EA corresponds to the average of the error rates of the color samples 70a and is expressed by the following Eq. (4), where the number of color samples 70a is denoted by M.

$${ε}_{A} = \frac{1}{M} {\sum }_{i = 1}^{M} {ε}_{i} \qquad ( 4 )$$

In the following, suppose that all the mask images included in the reconstruction table have the same average pixel value. Table 1 represents the relationship between the average pixel value of each mask image included in the reconstruction table and the reconstruction error. The number of bits for pixel values is 10, and the saturation value corresponding to the maximum pixel value is 1023.

TABLE 1

| | Average Pixel Value | | | | | | | | |
|---|---|---|---|---|---|---|---|---|---|
| | 50 | 80 | 100 | 200 | 300 | 400 | 600 | 800 | 900 |
| Recon- | 13.3 | 4.22 | 3.57 | 4.02 | 3.59 | 4.04 | 4.26 | 5.02 | 13.3 |
| struc- | | | | | | | | | |
| tion | | | | | | | | | |
| Error | | | | | | | | | |
| (%) | | | | | | | | | |

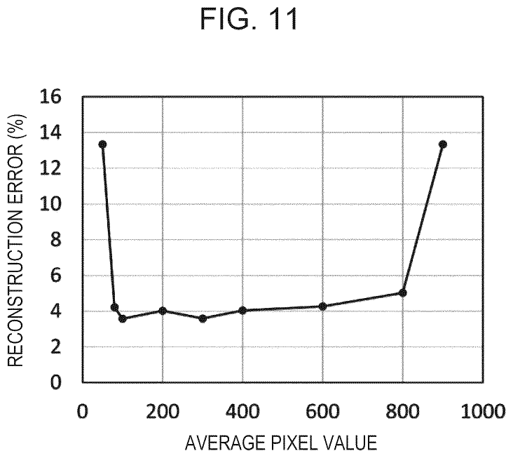

FIG. 11 is a graph representing the relationship between the average pixel value of each mask image included in the reconstruction table and the reconstruction error. As illustrated in FIG. 11, in a case where the average pixel value is extremely low, such as 50, or extremely high, such as 900, the reconstruction error exceeds 10%. In contrast, in a case where the average pixel value is greater than or equal to 80 and less than or equal to 800, the reconstruction error is less than or equal to about 5%. The upper limit of the reconstruction error allowed in practical use is about 5%.

For the average pixel value that enables a reduction in the reconstruction error, the value obtained by normalizing the lower limit, 80, with respect to the saturation value, 1023, is 0.0782, and the value obtained by normalizing the upper limit, 800, with respect to the saturation value, 1023, is 0.782. This means that if the value obtained by normalizing the average pixel value with respect to the saturation value is greater than or equal to about 0.08 and less than or equal to about 0.8, the hyperspectral image can be reconstructed more accurately from the compressed image than in a case where the value is not within that range.

The following is a discussion of the results illustrated in FIG. 11. In the encoding mask, regions have different transmittances for a certain wavelength band and are arranged irregularly. The processing circuit 210 performs the reconstruction operation using the reconstruction table obtained from such an encoding mask. The spatial distribution of pixel values in the mask image reflects the different transmittances in the regions of the encoding mask. The mask image in which the spatial distribution of pixel values is scattered to some extent and irregular is effective in achieving accurate reconstruction operation.

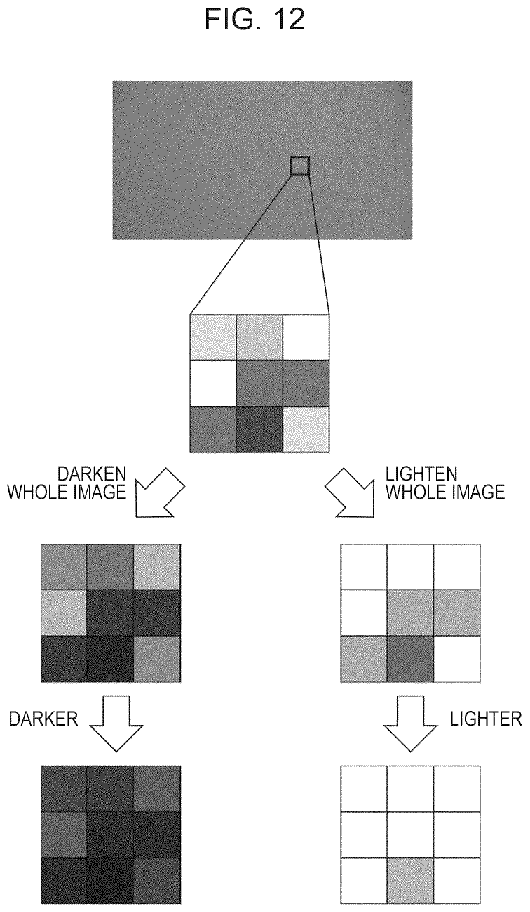

FIG. 12 is a schematic diagram illustrating the local spatial distributions of pixel values in the mask image corresponding to the certain wavelength band in an enlarged manner The squares illustrated in FIG. 12 represent pixels. Pixel values increase as the pixel color approaches white, and pixel values decrease as the pixel color approaches black.

In FIG. 12, as illustrated in two figures at the bottom left, the darker the whole mask image is, the lower the pixel values of the pixels included in the mask image. Thus, the spatial distribution of the pixel values becomes more uniform. As a result, for the pixels whose pixel values are supposed to be different, the pixel values of the pixels may be treated as the same value due to insufficient gradation to distinguish pixel value differences. In this manner, the irregularity of the spatial distribution of the pixel values is lost, and the reconstruction error increases.

In FIG. 12, as illustrated in two figures at the bottom right, the lighter the whole mask image is, the higher the pixel values of the pixels included in the mask image. Thus, the spatial distribution of the pixel values becomes more uniform. As a result, for the pixels whose pixel values are supposed to be different, the pixel values of the pixels may be treated as the same value because the pixel values cannot express further brightness due to pixel value saturation. For example, if the number of bits for the pixel values is 10, the maximum pixel value is 1023, and thus the pixels values of further brighter pixels are all 1023. In this manner, the irregularity of the spatial distribution of the pixel values is lost, and the reconstruction error increases.

For the above-mentioned reasons, as illustrated in FIG. 11, in a case where the average pixel value of each mask image is extremely low or extremely high, the reconstruction error increases. In contrast, in a case where the average pixel value of each mask image is not extremely low or not extremely high, the reconstruction error can be effectively reduced.

In the example illustrated in FIG. 11, all the mask images have the same average pixel value but are not limited to this example. In a case where the value obtained by normalizing the average pixel value of each mask image with respect to the saturation value is greater than or equal to about 8% and less than or equal to about 80%, all mask images do not need to have the same average pixel value. The mask images may have, for example, different average pixel values from each other. Alternatively, some of the mask images may have different average pixel values from that of the rest of the mask images. This is because the cause of the increased reconstruction error associated with the spatial distribution of the pixel values is that the average pixel value of each mask image is either extremely low or extremely high. Thus, whether or not all the mask images have the same average pixel value does not matter.

Note that even in a case where all the mask images have the same average pixel value, all the mask images do not need to have exactly the same average pixel value. For example, among the average pixel values corresponding to the respective mask images, the highest average pixel value and the lowest average pixel value may be in the range of ±10% of the average of the average pixel values.

If three mask images corresponding to three respective wavelength bands have average pixel values of 450, 500, and 550, the average of these three average pixel values is (450+500+550)/3=500, the highest average pixel value is 550, and the lowest average pixel value is 450. The highest average pixel value and the lowest average pixel value are in the range of ±10% of the average of the above-mentioned three average pixel values, namely the range greater than or equal to 450 and less than or equal to 550. Thus, it can be said that all three mask images have the same average pixel value.

From the above, in a case where the reconstruction table, which is matrix data including N submatrices, satisfies the following conditions, the imaging system according to the present embodiment can generate hyperspectral images more accurately from compressed images.

Regarding the upper limits of the average pixel values, in a case where the values obtained by normalizing the average pixel values with respect to the saturation value are less than or equal to about 0.8, the average pixel value of each mask image is not extremely high as illustrated in FIG. 11. In this case, when the maximum value of each numerical value included in each submatrix is denoted by M, the average of the numerical values included in an i-th submatrix (i is a natural number greater than or equal to 1 and less than or equal to N) among the N submatrices is denoted by μi, μi≤0.8 M for any i. Alternatively, it is possible that μi≤0.6 M so that μi is set to be sufficiently lower than the maximum pixel value.

Regarding the lower limits of the average pixel values, in a case where the values obtained by normalizing the average pixel values with respect to the saturation value are greater than or equal to about 0.08, the average pixel value of each mask image is not extremely low as illustrated in FIG. 11. In this case, for any i, μi≥0.08 M. Alternatively, it is possible that μi≥0.1 M, μi≥0.2 M, or μi≥0.4 M, so that μi is set to be sufficiently higher than the minimum pixel value.

The above-mentioned upper and lower limits of μi may be freely combined. For example, it is possible that 0.08 M≤μi≤0.8 M, 0.1 M≤μi≤0.8 M, 0.2 M≤μi≤0.8 M, or 0.4 M≤μi≤0.8 M. Alternatively, it is possible that 0.08 M≤μi≤0.6 M, 0.1 M≤μi≤0.6 M, 0.2 M≤μi≤0.6 M, or 0.4 M≤μi≤0.6 M.

### APPENDIX

The description of the above-mentioned embodiments discloses the following techniques.

### Technique 1

An imaging system including:
an imaging device that has an encoding element including regions whose transmission spectra differ from each other,
a memory device that stores matrix data including N submatrices corresponding to N respective wavelength bands, where N is an integer greater than or equal to 2, and
a processing circuit that generates N spectral images corresponding to the N respective wavelength bands, based on a compressed image generated by the imaging device in which information regarding the N wavelength bands is compressed and the matrix data, in which
each of the N submatrices includes numerical values,
the numerical values correspond to respective pixel values acquired through imaging based on light through the encoding element,
a maximum value of each of the numerical values corresponds to a maximum value determined by a number of bits set for a corresponding one of the pixel values, and
in a case where the maximum value of each of the numerical values is denoted by M and an average of the numerical values included in an i-th submatrix among the N submatrices is denoted by μi, where i is a natural number greater than or equal to 1 and less than or equal to N,
i that satisfies μi≤0.8 M exists.

This imaging system makes it possible to prevent μi from being extremely high and more accurately generate spectral images from images in which spectral information is compressed.

### Technique 2

The imaging system according to Technique 1, in which
μi≥0.08 M for any i.

This imaging system makes it possible to prevent μi from being extremely low and more accurately generate spectral images from images in which spectral information is compressed.

### Technique 3

The imaging system according to Technique 1 or 2, in which
μi≤0.6 M for any i.

This imaging system makes it possible to set μi to be sufficiently lower than the maximum pixel value.

### Technique 4

The imaging system according to any one of Techniques 1 to 3, in which
μi≥0.1 M for any i.

This imaging system makes it possible to set μi to be sufficiently higher than the minimum pixel value.

### Technique 5

The imaging system according to any one of Techniques 1 to 4, in which
each of the N submatrices is a two-dimensional matrix representing a two-dimensional distribution of the numerical values.

This imaging system makes it easier to understand, from each submatrix, the way in which pixel values for a certain wavelength band are distributed two-dimensionally.

### Technique 6

The imaging system according to any one of Techniques 1 to 4, in which
each of the N submatrices is a one-dimensional matrix in which the numerical values are arranged one-dimensionally.

This imaging system makes it possible to present the matrix data as a two-dimensional matrix.

### Technique 7

Matrix data used to generate N spectral images corresponding to N respective wavelength bands from a compressed image in which information regarding the N wavelength bands is compressed, where N is an integer greater than or equal to 2, the matrix data including:
N submatrices corresponding to the N respective wavelength bands, in which each of the N submatrices includes numerical values, in which
the numerical values correspond to respective pixel values acquired through imaging based on light through an encoding element including regions whose transmission spectra differ from each other,
a maximum value of each of the numerical values corresponds to a maximum value determined by a number of bits set for a corresponding one of the pixel values, and
in a case where the maximum value of each of the numerical values is denoted by M and an average of the numerical values included in an i-th submatrix among the N submatrices is denoted by μi, where i is a natural number greater than or equal to 1 and less than or equal to N,
i that satisfies μi≤0.8 M exists.

This matrix data makes it possible to more accurately generate spectral images from an image in which spectral information is compressed.

### Technique 8

A matrix data generation method performed by a computer, including:
causing an imaging device that has an encoding element including regions whose transmission spectra differ from each other to acquire N images of light corresponding to N respective wavelength bands under adjusted imaging conditions, where N is an integer greater than or equal to 2, and
generating matrix data including N submatrices corresponding to the N respective images of light, in which
the matrix data is used to generate N spectral images corresponding to the N respective wavelength bands from a compressed image in which the N wavelength bands are compressed,
each of the N submatrices includes numerical values,
the numerical values correspond to respective pixel values acquired through imaging based on light through the encoding element including regions whose transmission spectra differ from each other,
a maximum value of each of the numerical values corresponds to a maximum value determined by a number of bits set for a corresponding one of the pixel values, and in a case where the maximum value of each of the numerical values is denoted by
M and an average of the numerical values included in an i-th submatrix among the N submatrices is denoted by μi, where i is a natural number greater than or equal to 1 and less than or equal to N,
i that satisfies μi≤0.8 M exists.

This method makes it possible to obtain matrix data that enables more accurate generation of spectral images from an image in which spectral information is compressed.

### Other 1

An imaging system, matrix data, and a matrix data generation method according to the present disclosure are not limited to the above-mentioned embodiment. Other embodiments realized by combining any of the structural elements in the above-mentioned embodiment, and modifications conceived by those skilled in the art by making various changes to the above-mentioned embodiment, without departing from the gist of the present disclosure, are also included in the present disclosure.

### Other 2

A modification of the embodiment of the present disclosure may be as illustrated below.

An imaging system including:
a filter array that includes a filter F(1, 1) having a transmittance characteristic c(1, 1) in a wavelength range W, . . . , and a filter F(n, m) having a transmittance characteristic c(n, m) in the wavelength range W,
an image sensor that includes pixels from p(1, 1) to p(n, m),
a memory that stores first data including values from h1(1, 1) to h1(n, m), . . . , and N-th data including values from hN(1, 1) to hN(n, m), and
an image processing apparatus, in which
the wavelength range W includes a first wavelength range through an N-th wavelength range,
the image sensor captures an image of a subject through the filter array and outputs the image including pixel values, the pixel values include pixel values from pg(1, 1) to pg(n, m), the pixel p(1, 1) corresponds to the pixel value pg(1, 1), . . . , the pixel p(n, m) corresponds to the pixel value pg(n, m),
the image processing apparatus
generates, on the basis of the pixel values and the first data, a first image corresponding to the first wavelength range and including pixel values from pf1(1, 1) to pf1(n, m) and generates, on the basis of the pixel values and the N-th data, an N-th image corresponding to the N-th wavelength range and including pixel values from pfN(1, 1) to pfN(n, m),
a maximum value of the values from h1(1, 1) to h1(n, m) is a first maximum value M1, . . . , a maximum value of the values from hN(1, 1) to hN(n, m) is an N-th maximum value MN,
an average value of the values from h1(1, 1) to h1(n, m) is less than or equal to M1×0.8, . . . , an average value of the values from hN(1, 1) to hN(n, m) is less than or equal to MN×0.8,

$$\begin{matrix}g = Hf , \\ H = ( H 1 … HN ) , \\ \\ H 1 = ( \begin{matrix}h 1 ( 1 , 1 ) & … & h 1 ( 1 , m ) \\ ⋮ & ⋱ & ⋮ \\ h 1 ( n , 1 ) & … & h 1 ( n , m )\end{matrix} ) , … , HN = ( \begin{matrix}h N ( 1 , 1 ) & … & h N ( 1 , m ) \\ ⋮ & ⋱ & ⋮ \\ h N ( n , 1 ) & … & h N ( n , m )\end{matrix} ) \\ g = {( p g ( 1 , 1 ) … pg ( n , m ) )}^{T} , \\ f = {( {f}_{1} … {f}_{N} )}^{T} = {( pf 1 ( 1 , 1 ) … pf 1 ( n , m ) … pfN ( 1 , 1 ) … pfN ( n , m ) )}^{T} , and \\ {f}_{1} = ( pf 1 ( 1 , 1 ) … pf 1 ( n , m ) ) , … , {f}_{N} = ( pfN ( 1 , 1 ) … pfN ( n , m ) ) .\end{matrix} \qquad ( 5 )$$

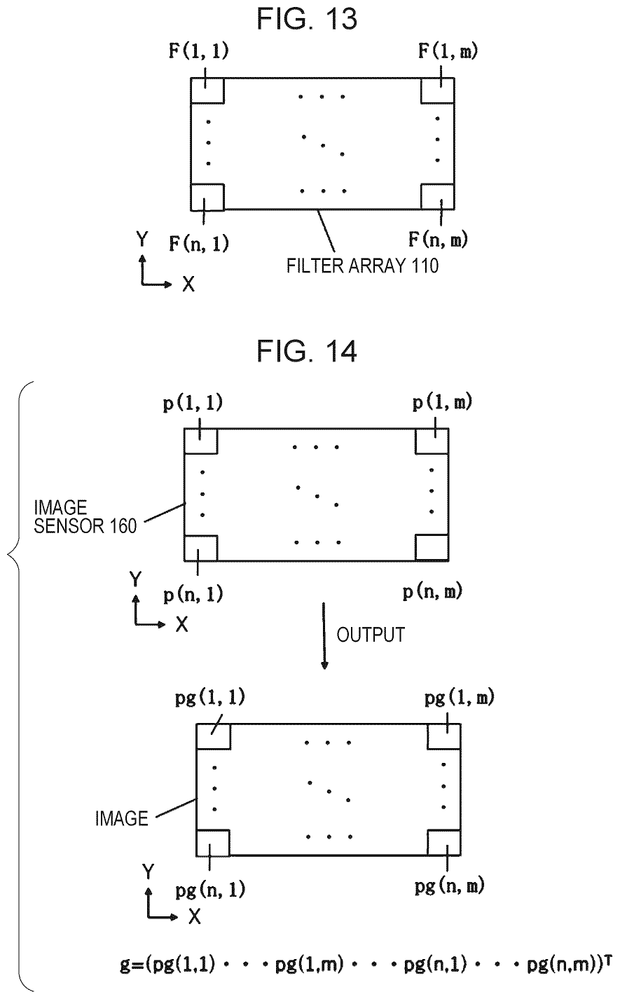

The above-mentioned modification will be described using FIGS. 13, 14, and 15.

FIG. 13 is a diagram for describing an example of the filter array.

FIG. 14 is a diagram for describing an example of the image sensor.

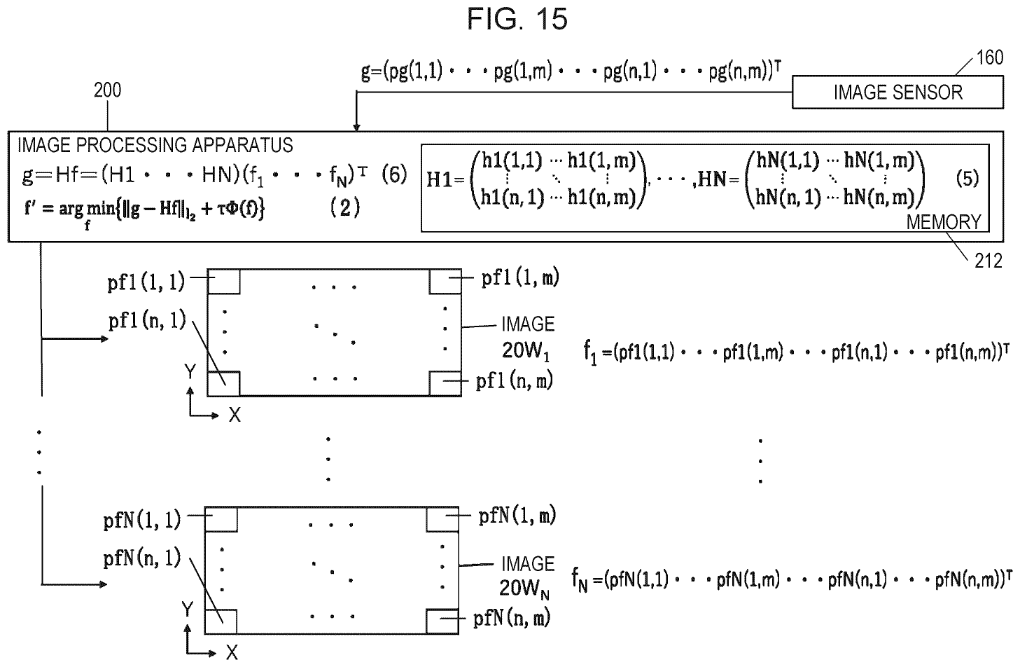

FIG. 15 is a diagram for describing an example of the image processing apparatus 200.

The filter array 110 may include the filter F(1, 1) having the transmittance characteristic c(1, 1) in the wavelength range W, . . . , and the filter F(n, m) having the transmittance characteristic c(n, m) in the wavelength range W (see FIG. 13).

The image sensor 160 may include the pixel p(1, 1), . . . , and the pixel p(n, m) (see FIG. 14).

The memory 212 may store the first data including the values from h1(1, 1) to h1(n, m), . . . , and the N-th data including the values from hN(1, 1) to hN(n, m) (see FIG. 15).

The image processing apparatus 200 may include the memory 212. Alternatively, the image processing apparatus 200 does not have to include the memory 212. That is, the memory 212 may be provided outside the image processing apparatus 200.

The wavelength range W may include the first wavelength range through the N-th wavelength range (see FIGS. 3A and 3B).

The image sensor 160 may capture an image of a subject through the filter array 110 and output the image that includes pixel values (see FIGS. 1A to 1D). The pixel values may include the pixel values from pg(1, 1) to pg(n, m). The pixel p(1, 1) may correspond to the pixel value pg(1, 1), . . . , and the pixel p(n, m) may correspond to the pixel value pg(n, m). (See FIG. 14) The image processing apparatus 200 may generate, on the basis of the pixel values and the first data, the first image corresponding to the first wavelength range and including the pixel values from pf1(1, 1) to pf1(n, m) and generates, on the basis of the pixel values and the N-th data, the N-th image corresponding to the N-th wavelength range and including the pixel values from pfN(1, 1) to pfN(n, m) (see FIG. 15, Eq. (1), Eq. (2)). In FIG. 15, the first image is described as an image 20W₁, . . . , and the N-th image is described as an image 20W_{N}. The first image may be the reconstructed image (reconstruction image) 20W₁ described in the above-mentioned embodiment, . . . , and the N-th image may be the reconstructed image (reconstruction image) 20W_{N} described in the above-mentioned embodiment.

The maximum value of the values from h1(1, 1) to h1(n, m) may be the first maximum value M1, . . . , and the maximum value of the values from hN(1, 1) to hN(n, m) may be the N-th maximum value MN.

The average value of the values from h1(1, 1) to h1(n, m) may be less than or equal to M1×0.8, . . . , and the average value of the values from hN(1, 1) to hN(n, m) may be less than or equal to MN×0.8.

It is possible that g=Hf,

$$H = ( H 1 … HN ) , \qquad ( 5 )$$

$$H 1 = ( \begin{matrix}h 1 ( 1 , 1 ) & ⋯ & h 1 ( 1 , m ) \\ ⋮ & ⋱ & ⋮ \\ h 1 ( n , 1 ) & ⋯ & h 1 ( n , m )\end{matrix} ) , … , HN = ( \begin{matrix}h N ( 1 , 1 ) & ⋯ & h N ( 1 , m ) \\ ⋮ & ⋱ & ⋮ \\ h N ( n , 1 ) & ⋯ & h N ( n , m )\end{matrix} ) ,$$

$$\begin{matrix}g = {( pg ( 1 , 1 ) … pg ( n , m ) )}^{T} , \\ f = {( {f}_{1} … {f}_{N} )}^{T} = {( pf 1 ( 1 , 1 ) … pf 1 ( n , m ) … pfN ( 1 , 1 ) … pfN ( n , m ) )}^{T} , and \\ {f}_{1} = ( pf 1 ( 1 , 1 ) … pf 1 ( n , m ) ) , … , {f}_{N} = ( pfN ( 1 , 1 ) … pfN ( n , m ) ) .\end{matrix}$$

A modification of the embodiment of the present disclosure may be illustrated as follows.

The modification may include an imaging device that has an encoding element including regions whose transmission spectra differ from each other.

The modification may include a memory device that stores matrix data including N submatrices corresponding to N respective wavelength bands (N is an integer greater than or equal to 2).

The modification may include a processing circuit that generates N spectral images corresponding to the N respective wavelength bands on the basis of the compressed image generated by the imaging device in which information regarding the N wavelength bands is compressed and the matrix data.

Each of the N submatrices may include numerical values.

The numerical values may correspond to respective pixel values acquired through imaging based on light through the encoding element.

The maximum value of each of the numerical values may correspond to the maximum value determined by the number of bits set for the corresponding one of the pixel values.

When the maximum value of each of the numerical values is denoted by M and the average of the numerical values included in an i-th submatrix (i is a natural number greater than or equal to 1 and less than or equal to N) among the N submatrices is denoted by μi, i that satisfies μi≤0.8 M may exist. In other words, μi≤0.8 M does not need to be satisfied for all i. This makes it possible to more accurately generate spectral images corresponding to the i-th wavelength band that satisfies μi≤0.8 M.

For example, when N=4, μl≤0.8 M, μ2≤0.8 M, and μ4≤0.8 M. In this case, it is possible that μ3>0.8 M. In this case, a spectral image corresponding to the first wavelength band, a spectral image corresponding to the second wavelength band, and a spectral image corresponding to the fourth wavelength band can be generated more accurately.

For i that satisfies μi≤0.8 M, it is possible that μi≥0.08 M. This makes it possible to more accurately generate a spectral image corresponding to the i-th wavelength band that satisfies 0.08 M≤μi≤0.8 M.

Based on K spectral images corresponding to K submatrices (1≤K<N) corresponding to i that satisfies μi≤0.8 M, subject analysis processing may be performed. In other words, the subject analysis processing is performed using the spectral images generated on the basis of the submatrices corresponding to i that satisfies μi≤0.8 M, and the spectral images generated on the basis of the submatrices corresponding to i that does not satisfy μi≤0.8 M do not have to be used in the subject analysis processing. This makes it possible to perform more accurate analysis using the spectral images corresponding to the i-th wavelength band that satisfies μi≤0.8 M. For example, in a case where N=4, μl≤0.8 M, μ2≤0.8 M, μ4≤0.8 M, and μ3≥0.8 M, the analysis processing is performed on the basis of the spectral image corresponding to the first wavelength band, the spectral image corresponding to the second wavelength band, and the spectral image corresponding to the fourth wavelength band, and the spectral image corresponding to the third wavelength band does not have to be used.

The analysis processing may be, for example, an inspection to determine the presence or absence of foreign matter in or on a subject, an inspection to determine coating quality, or a pharmaceutical inspection. The subject may be an electric component, food, etc. The analysis processing may be a substance concentration analysis or various component analyses.

The subject analysis processing may be performed on the basis of K spectral images corresponding to K submatrices (1≤K<N) corresponding to i that satisfies 0.08 M≤μi≤0.8 M. In other words, the subject analysis processing is performed using the spectral images generated on the basis of submatrices corresponding to i that satisfies 0.08 M≤μi≤0.8 M, and the spectral images generated on the basis of submatrices corresponding to i that does not satisfy 0.08 M≤μi≤0.8 M do not have to be used in the subject analysis processing.

The technology according to the present disclosure is useful, for example, in cameras and measurement devices that acquire multi-wavelength or high-resolution images. The technology according to the present disclosure can be applied, for example, to sensing for biological, medical, and cosmetic applications, inspection systems for foreign matter and pesticide residues in food, remote sensing systems, and in-vehicle sensing systems.

What is claimed is:

1. An imaging system comprising:
an imaging device that has an encoding element including regions whose transmission spectra differ from each other;
a memory device that stores matrix data including N submatrices corresponding to N respective wavelength bands, where N is an integer greater than or equal to 2; and
a processing circuit that generates N spectral images corresponding to the N respective wavelength bands, based on a compressed image generated by the imaging device in which information regarding the N wavelength bands is compressed and the matrix data, wherein
each of the N submatrices includes numerical values,
the numerical values correspond to respective pixel values acquired through imaging based on light through the encoding element,
a maximum value of each of the numerical values corresponds to a maximum value determined by a number of bits set for a corresponding one of the pixel values, and
in a case where the maximum value of each of the numerical values is denoted by M and an average of the numerical values included in an i-th submatrix among the N submatrices is denoted by μi, where i is a natural number greater than or equal to 1 and less than or equal to N,
i that satisfies μi≤0.8 M exists.

2. The imaging system according to claim 1, wherein
for i that satisfies μi≤0.8 M, μi≥0.08 M.

3. The imaging system according to claim 1, wherein
the processing circuit
performs subject analysis processing, based on K spectral images that correspond to K submatrices corresponding to i that satisfies μi≤0.8 M, where 1≤K<N.

4. The imaging system according to claim 1, wherein
for any i, μi≤0.8 M.

5. The imaging system according to claim 1, wherein
for any i, μi≥0.08 M.

6. The imaging system according to claim 1, wherein
for any i, μi≤0.6 M.

7. The imaging system according to claim 1, wherein
for any i, μi≥0.1 M.

8. The imaging system according to claim 1, wherein
each of the N submatrices is a two-dimensional matrix representing a two-dimensional distribution of the numerical values.

9. The imaging system according to claim 1, wherein
each of the N submatrices is a one-dimensional matrix in which the numerical values are arranged one-dimensionally.

10. Matrix data used to generate N spectral images corresponding to N respective wavelength bands from a compressed image in which information regarding the N wavelength bands is compressed, where N is an integer greater than or equal to 2, the matrix data comprising:
N submatrices corresponding to the N respective wavelength bands, wherein each of the N submatrices includes numerical values, wherein
the numerical values correspond to respective pixel values acquired through imaging based on light through an encoding element including regions whose transmission spectra differ from each other,
a maximum value of each of the numerical values corresponds to a maximum value determined by a number of bits set for a corresponding one of the pixel values, and
in a case where the maximum value of each of the numerical values is denoted by M and an average of the numerical values included in an i-th submatrix among the N submatrices is denoted by μi, where i is a natural number greater than or equal to 1 and less than or equal to N,
i that satisfies μi≤0.8 M exists.

11. A matrix data generation method performed by a computer, comprising:
causing an imaging device that has an encoding element including regions whose transmission spectra differ from each other to acquire N images of light corresponding to N respective wavelength bands under adjusted imaging conditions, where N is an integer greater than or equal to 2; and
generating matrix data including N submatrices corresponding to the N respective images of light, wherein
the matrix data is used to generate N spectral images corresponding to the N respective wavelength bands from a compressed image in which the N wavelength bands are compressed,
each of the N submatrices includes numerical values,
the numerical values correspond to respective pixel values acquired through imaging based on light through the encoding element including regions whose transmission spectra differ from each other,
a maximum value of each of the numerical values corresponds to a maximum value determined by a number of bits set for a corresponding one of the pixel values, and
in a case where the maximum value of each of the numerical values is denoted by M and an average of the numerical values included in an i-th submatrix among the N submatrices is denoted by μi, where i is a natural number greater than or equal to 1 and less than or equal to N,
i that satisfies μi≤0.8 M exists.
